(19) United States
(12) Patent Application Publication
(10) Pub. No.: US 2019/0195601 A1
(43) Pub. Date: Jun. 27, 2019

(54) A METHOD FOR NEUTRALIZING A THREAT

(71) Applicant: Mordechay FINKENBERG, Gedera (IL)

(72) Inventor: Mordechay FINKENBERG, Gedera (IL)

(21) Appl. No.: 16/323,836

(22) PCT Filed: Aug. 7, 2017
(86) PCT No.: PCT/IL2017/000005

§ 371 Date: Feb. 7, 2019

(30) Foreign Application Priority Data
Aug. 7, 2016 (IL) 247138

(51) Int. Cl. F41H 13/00; F41H 11/02; F42B 12/20

(52) U.S. Cl. CPC F41H 13/0093; F42B 12/207; F42B 12/202; F41H 11/02

(57) ABSTRACT

A method for neutralizing a threat, include: detecting an oncoming object prima facie aimed at a protected platform. In response to the detecting, classifying the object as an Anti-Tank-Guided Missile (ATGM) threat. In response to said classification, calculating fire characteristics of the interceptor, such that the ATGM threat will fall an Electro-Magnetic-Pulse induced neutralization geometric envelope relative to the interceptor, for achieving a neutralization effect of the threat, and firing said interceptor that is equipped with at least an Electro-Magnetic-Pulse warhead according to the fire characteristics.

### FIELD OF THE INVENTION

The present invention is in the general field of Electro-Magnetic-Pulse (EMP) based warheads.

### BACKGROUND OF THE INVENTION

As is well known, an Electromagnetic Pulse (EMP) is a short burst of electromagnetic energy. An EMP is in many cases referred to as EMP interference in the context of damaging electronic equipment (see e.g. en.wikipedia.org/wiki/electromagnetic pulse). Note that an EMP may also be used in the context of a single use EMP generator driven by explosives (see e.g. n.wikipedia.org/wiki/Explosively_pumped_flux_compression_generator.

The modern battlefield has introduced challenging threats to armored vehicles, (such as tanks) e.g. anti-tank-guided weapons, specifically Anti-Tank Guided Missiles—ATGMs—such as the Russian made Kornet. The latter may cause lethal damage to the tank platform and crew.

There are a few known in the art ATGM generations. The first generation includes Manually Controlled Line of Sight (MCLOS) such the AT-3A, SAGGER, SS10 etc. The second generation includes Semi-Automatic Controlled Line of Sight (SACLOS), such as TOW, KORNET etc., and the third generation includes fully automatic control (“shoot and forget”), such as PARS 3 LR and SPIKE etc.

The introduction of the ATGM has led to the development of Armored Shield Protection (ASPRO) systems that are mounted as a supplemental system on the armored vehicle platform and are designated to kill (destroy or drastically diminish the lethal effect of) the ATGMs. The most advanced systems are active solutions (ASPRO-A) such as the “Trophy” (known also as the “Windbreaker”) used by the Israeli Defense Forces and commercially available by RAFAEL Advanced Defense Systems and Israeli Aerospace Industries-Elta Group, Israel.

While the active ASPRO-A achieves the kill at a safe distance off the platform, it nevertheless occurs within the so called “end game” phase of the oncoming threat, leaving no time for a second try if the system misses its target.

For a better understanding of the foregoing, attention is first drawn to FIG. 1, illustrating a schematic chart of an operational scenario of a system, in accordance with the prior art. As shown, an Anti-Tank-Guided Missile (ATGM) 1 is launched from launcher 2, generally towards a protected platform, such as tank 3 employing the system (such as the Russian made Arena and Drozdas, or the Israeli Trophy). The missile is not a priori classified as a threat but rather detected after a relatively short time duration 4 by detection module (not shown in FIG. 1) fitted on the protected platform 3. The detection system may be a known per se radar system and/or optical (e.g. Infra-Red based) system. After having detected the flying object (at this stage not classified as yet as a target missile) there follows a verification stage for classifying the flying object as a target missile that is aimed at the protected platform. As shown, this may occur after elapse of a verification time interval during which the missile continues its flight trajectory (5) towards the protected platform. The verification stage is realized by a known per se verification module (employing e.g. the specified optical module and associated computer system) and includes tracking the flying object, and is determined based on calculated Angle of Arrival (AOA) (calculating an approach vector) for ascertaining whether the object is flying towards the protected platform (in which case it may be classified as a target missile), or not, in which case it may be ignored as it does not pose any risk to the protected platform.

After having classified the target as a threat, the target missile is tracked and when it approaches the protected platform, e.g. during the end-game approach phase of the target missile, an interceptor 6 is launched from the protected platform and achieves a hard killing of the target missile at an interception point 7 being typically at a distance of tens of meters from the protected platform.

There is a need in the art to provide for a new system for neutralizing an Anti-Armored Vehicle Guided Weapon at longer ranges.

### SUMMARY OF THE INVENTION

In accordance with an aspect of the invention there is provided a method for neutralizing a threat, comprising:
a) detecting an oncoming object prima facie aimed at a protected platform;
b) in response to the detecting, classifying the object as an Anti-Tank-Guided Missile (ATGM) threat;
c) in response to the classification, calculating fire characteristics of the interceptor, such that the ATGM threat will fall within an Electro-Magnetic-Pulse induced neutralization geometric envelope relative to the interceptor, for achieving a neutralization effect of the threat,
d) firing the interceptor that is equipped with at least an Electro-Magnetic-Pulse warhead according to the fire characteristics,
e) in response to the threat falling within the neutralization geometric envelope, initiating the EMP warhead, for achieving a stand-off neutralization of the threat at a range substantially farther than the end-game intercept range, and irrespective of the type of the target missile; and wherein the neutralization geometric envelope has larger volumetric dimensions by a factor of at least 10 than the volumetric dimensions of a second envelope, had a High-Explosive (HE) warhead with substantially the same size and/or weight as that of the EMP warhead been used, for achieving substantially the same neutralization effect.

In accordance with an embodiment of the invention there is further provided a method, wherein in case the interceptor being a missile, the fire characteristics include: calculating flight direction towards an optical signature that originates from the launcher or detecting an optical signature of the ATGM's engine during its flight trajectory.

In accordance with an embodiment of the invention there is yet further provided a method, wherein in case the interceptor being a projectile or rocket and the fire characteristics include calculating a fire elevation angle of the interceptor, such an ATGM threat will fall within the envelope.

In accordance with an embodiment of the invention there is yet further provided a method, wherein the classifying the object as an ATGM threat aimed at the protected platform, includes measuring and processing an Angle of Arrival (AOA) of the oncoming object, and in case that it is retained substantially fixed within a given tolerance, then the object is classified as the threat, or velocity vector of the approaching object is calculated for classifying the object as a threat.

In accordance with an embodiment of the invention there is yet further provided a method, wherein the neutralizing includes permanently rendering inoperable at least one of electronic/electrical modules of the ATGM threat.

In accordance with an embodiment of the invention there is yet further provided a method, wherein the electrical\electronic modules include a power supply module, a communication module for communicating between the target missile and its launcher and/or a remote command and control thereof, navigation module of the missile and steering control module.

In accordance with an embodiment of the invention there is yet further provided a method, wherein the neutralizing includes temporarily rendering inoperable at least one electrical/electronic module of the ATGM threat.

In accordance with an embodiment of the invention there is yet further provided a method, wherein the electrical\electronic modules include a power supply module, a communication module for communicating between the target missile its launcher and/or a remote command and control thereof, navigation module of the missile and steering control module.

In accordance with an embodiment of the invention there is yet further provided a method wherein the initiating of the EMP warhead being when the range from the interceptor's launcher to the interceptor substantially coincides with range from the interceptor's launcher to the threat.

In accordance with an embodiment of the invention there is yet further provided a method wherein the range being in the order of more than 100 meters.

In accordance with an embodiment of the invention there is yet further provided a method wherein the initiating being responsive to a range data obtained by a radar system associated with the interceptor launcher and being transmitted to the interceptor.

In accordance with an embodiment of the invention there is yet further provided a method, wherein the initiating being responsive to a cross signal originating from at least one proximity fuse module fitted on-board the interceptor.

In accordance with an embodiment of the invention there is yet further provided a method, wherein the proximity fuse module is activated in response to range data obtained by a tracking system associated with the interceptor launcher.

In accordance with an embodiment of the invention there is yet further provided a method, wherein the interceptor being a single-stage type interceptor.

In accordance with an embodiment of the invention there is yet further provided a method, wherein the interceptor being a dual-stage type interceptor.

In accordance with an embodiment of the invention there is yet further provided a method, wherein the protected platform being a tank.

In accordance with an aspect of the invention there is yet further provided a Self Protection System Control (SPS-C) for neutralizing a threat, comprising:
a computer system coupled to a tracking system and communication module; the SPS-C being configured to
a) detect an oncoming object prima facie aimed at a protected platform;
b) in response to the detecting, classifying the object as an Anti-Tank-Guided Missile (ATGM) threat;
c) in response to the classification, calculating fire characteristics of the interceptor, such that the ATGM threat will fall within an Electro-Magnetic-Pulse induced neutralization geometric envelope relative to the interceptor, for achieving a neutralization effect of the threat,
d) command firing the interceptor that is equipped with at least Electro-Magnetic-Pulse warhead according to the fire characteristics,
e) track the interceptor and the threat and in response to the ATGM threat falling within the neutralization geometric envelope relative to the interceptor, transmitting an activation command to the interceptor, for achieving a stand-off neutralization of the threat at a range substantially farther than the end-game intercept range, and irrespective of the type of the target missile,
   and wherein the neutralization geometric envelope has larger volumetric dimensions by a factor of at least 10 than the volumetric dimensions of a second envelope, had a High-Explosive (HE) warhead with substantially the same size and/or weight as that of the EMP warhead been used, for achieving substantially the same neutralization effect.

In accordance with an embodiment of the invention there is yet further provided a system, wherein the command is transmitted to the interceptor for initiating the EMP warhead.

In accordance with an embodiment of the invention there is yet further provided a system, wherein the command is transmitted to the interceptor for activating at least one proximity fuse module fitted on the interceptor.

In accordance with an embodiment of the invention there is yet further provided a system being a passive tracking system for at least detecting the on-coming object.

In accordance with an embodiment of the invention there is yet further provided a system, wherein the tracking system being an active tracking system, for at least detecting the on-coming object.

In accordance with an embodiment of the invention there is yet further provided a system, wherein the system is configured to fire the interceptor wherein the interceptor being a missile, and wherein the computer system is configured to calculate the fire characteristics including calculating flight direction towards an optical signature that originates from the launcher or to the detection of optical signature of the ATGM's engine during its flight trajectory.

In accordance with an embodiment of the invention there is yet further provided a system, wherein the system is configured to fire the interceptor wherein the interceptor being a projectile or rocket and wherein the computer system is configured to calculate the fire characteristics including calculating a fire elevation angle of the interceptor such that the ATGM threat will fall within the envelope.

In accordance with an embodiment of the invention there is yet further provided a system, wherein the computer system is configured to classify the object as an ATGM threat aimed at the protected platform including processing an Angle of Arrival (AOA) of the oncoming object and in case that it is retained substantially fixed within a given tolerance, then the object is classified as the threat or calculating the velocity vector of the approaching object for classifying the object as a threat.

In accordance with an embodiment of the invention there is yet further provided a system, wherein the neutralizing includes permanently rendering inoperable at least one of the electronic/electrical modules of the threat.

In accordance with an embodiment of the invention there is yet further provided a system, wherein the electrical\electronic modules include a power supply module, a communication module for communicating between the threat and its launcher and/or a remote command and control thereof, navigation module of the missile and steering control module.

In accordance with an embodiment of the invention there is yet further provided a system, wherein the neutralizing includes temporarily rendering inoperable at least one electrical/electronic module of the threat.

In accordance with an embodiment of the invention there is yet further provided a system, wherein the electrical\electronic modules include a power supply module, a communication module for communicating between the threat, its launcher and/or a remote command and control thereof, navigation module of the missile and steering control module.

In accordance with an embodiment of the invention there is yet further provided a system, wherein the initiating of the EMP warhead being when the range from the interceptor's launcher to the interceptor substantially coincides with range from the interceptor's launcher to the threat missile.

In accordance with an embodiment of the invention there is yet further provided a system, wherein the range being in the order of more than 100 meters.

In accordance with an embodiment of the invention there is yet further provided a system, wherein the initiating being responsive to a range data obtained by an active tracking system associated with an interceptor launcher and being transmitted to the interceptor.

In accordance with an embodiment of the invention there is yet further provided a system, wherein the interceptor being a single-stage type interceptor.

In accordance with an embodiment of the invention there is yet further provided a method, wherein the interceptor being a dual-stage type interceptor.

In accordance with an embodiment of the invention there is yet further provided a method, wherein the protected platform being a tank.

In accordance with an aspect of the invention there is yet further provided a Self Protection System Control (SPS-C) for neutralizing a threat, comprising:
a computer system coupled to a tracking system and communication module;
the SPS-C being configured to
a) detect an oncoming object prima facie aimed at a protected platform and the direction and range of the launcher in response to sensing optical signature originated from the launch of the threat;
b) in response to the detecting, classifying the object as an Anti-Tank-Guided Missile (ATGM) threat;
c) in response to the classification, calculating fire characteristics of a fast flying interceptor based on the direction and range, wherein the fast flying projectile having substantially faster flight velocity than the threat, such that the interceptor will fall within an Electro-Magnetic-Pulse induced neutralization geometric envelope relative to the launcher, for achieving a neutralization effect of the launcher,
d) command firing the fast flying interceptor that is equipped with at least Electro-Magnetic-Pulse warhead according to the fire characteristics, for neutralizing the launcher and consequently the threat before the latter has arrived at the protected platform;
   wherein the neutralization geometric envelope has larger volumetric dimensions by a factor of at least 10 than the volumetric dimensions of a second envelope, had a High-Explosive (HE) warhead with substantially the same size and/or weight as that of the EMP warhead been used, for achieving substantially the same neutralization effect.

### BRIEF DESCRIPTION OF THE DRAWINGS

For a better understanding, the invention will now be described by way of example only with reference to the accompanying drawings, in which:

FIG. 1 is a schematic chart of an operational scenario of a system, in accordance with the prior art;

FIGS. 2A-D illustrate schematic charts of an operational scenario of a self protection system for stand-off neutralization of a threat, in accordance with certain embodiments of the invention;

FIGS. 2E-H illustrate schematic charts of another operational scenario of a self protection system for stand-off neutralization of a threat, in accordance with certain embodiments of the invention;

FIG. 3 is a schematic illustration of a self protection system (SPS) layout, mounted on a protected platform, in accordance with certain embodiments of the invention;

FIG. 4A is a generalized self protection system control (SPS-C) architecture in accordance with certain embodiments of the invention;

FIG. 4B illustrates schematically modules that are fitted in an interceptor of an SPS, in accordance with certain embodiments of the invention;

FIG. 4C is a schematic illustration of electric/electronic modules fitted in an Anti-Tank Guided Missile (ATGM) threat targeted by a system, in accordance with certain embodiments of the invention;

FIG. 5 is a flow chart of a sequence of operations for realizing a stand-off neutralization of a threat (ATGM) with a single stage interceptor of an SPS system, in accordance with certain embodiments of the invention;

FIG. 6 is a flow chart of a sequence of operations for realizing a stand-off neutralization of a threat (ATGM) with a single stage interceptor, of an SPS system in accordance with certain embodiments of the invention;

FIG. 7A illustrates an Electro-Magnetic-Pulse induced neutralization geometric envelope, for stand-off neutralization engagement, in accordance with certain embodiments of the invention;

FIG. 7B illustrates an Electro-Magnetic-Pulse induced neutralization geometric envelope, for stand-off neutralization engagement, broken down by soft-kill and hard-kill envelopes, in accordance with certain embodiments of the invention;

FIG. 7C illustrates an Electro-Magnetic-Pulse induced neutralization geometric envelope in various operational scenarios, in accordance with certain embodiments of the invention;

FIG. 8 illustrates schematically a dual-stage interceptor of an SPS system, in accordance with certain embodiments of the invention;

FIGS. 9A-F illustrate schematic charts of an operational scenario of a system for stand-off neutralization of a threat utilizing a dual-stage interceptor, in accordance with certain embodiments of the invention; and

FIG. 10 is a flow chart of a sequence of operations for realizing a stand-off neutralization of a threat (ATGM) and a launcher with a dual stage interceptor of an SPS system, in accordance with certain embodiments of the invention.

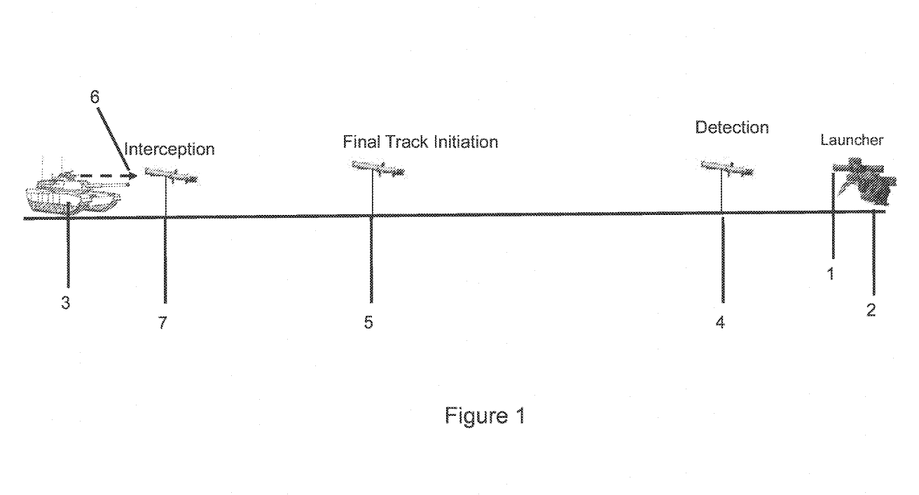

### DESCRIPTION OF SPECIFIC EMBODIMENTS

While a protected platform is generally exemplified in the context of the description below as a tank, the invention is not bound by this example and any other protected platform, whether stationary (such as a building) or moving, such as a tank, that may serve as a target to an anti-tank guided missile (, is embraced by the various embodiments of the invention.

Moreover, in the context of the present invention, a protected platform may be a maritime vehicle such as a ship in which case the attacking missile is anti-ship missile, and the description below in connection with neutralizing an ATGM applies to Anti-Ship-Missile mutatis mutandis. For convenience, the specified anti-tank guided missile and anti-ship missile will be referred collectively as Anti-Tank-Guided-Missile (ATGM).

In the following detailed description, numerous specific details are set forth in order to provide a thorough understanding of the presently disclosed subject matter. However, it will be understood by those skilled in the art that the presently disclosed subject matter may be practiced without these specific details. In other instances, well-known methods, procedures, components and circuits have not been described in detail so as not to obscure the presently disclosed subject matter.

Unless specifically stated otherwise, as apparent from the following discussions, it is appreciated that throughout the specification discussions utilizing terms such as “calculating”, “processing”, “neutralizing”, “detecting” “classifying”, “initiating”, “measuring”, “transmitting”, “communicating”, “rendering” or the like, refer to the action(s) and/or process(es) of a computer that manipulate and/or transform data into other data, said data represented as physical, such as electronic, quantities and/or said data representing the physical objects. The term “computer system” should be expansively construed to cover any kind of electronic device(s) with data processing capabilities.

The computer system operations in accordance with the teachings herein may be performed by a computer(s) specially constructed for the desired purposes or by a general-purpose computer(s) specially configured for the desired purpose by a computer program stored in a computer readable storage medium.

Embodiments of the presently disclosed subject matter are not described with reference to any particular programming language. It will be appreciated that a variety of programming languages may be used to implement the teachings of the presently disclosed subject matter as described herein.

The term computer system includes a single computer/processing unit or a plurality of distributed or remote such units.

Data can be stored on one or more tangible or intangible computer readable media stored at one or more different locations, different network nodes or different storage devices at a single node or location.

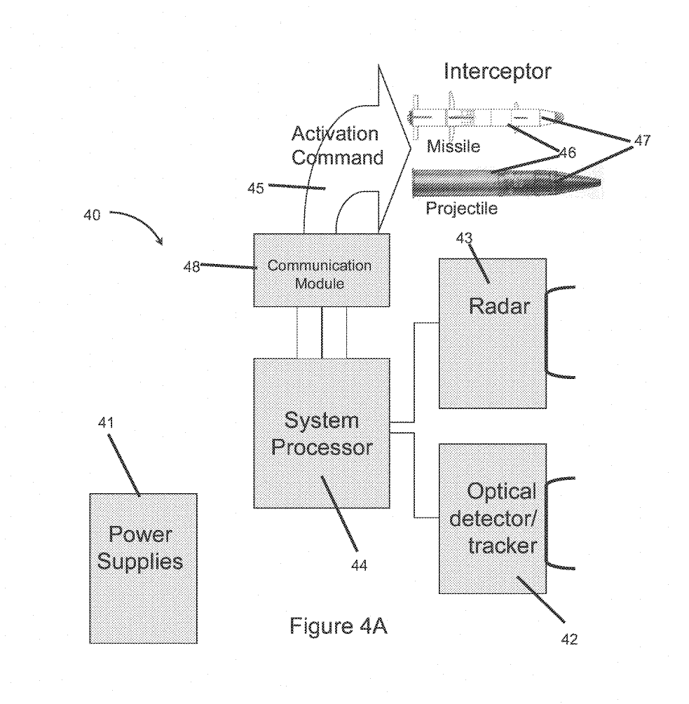

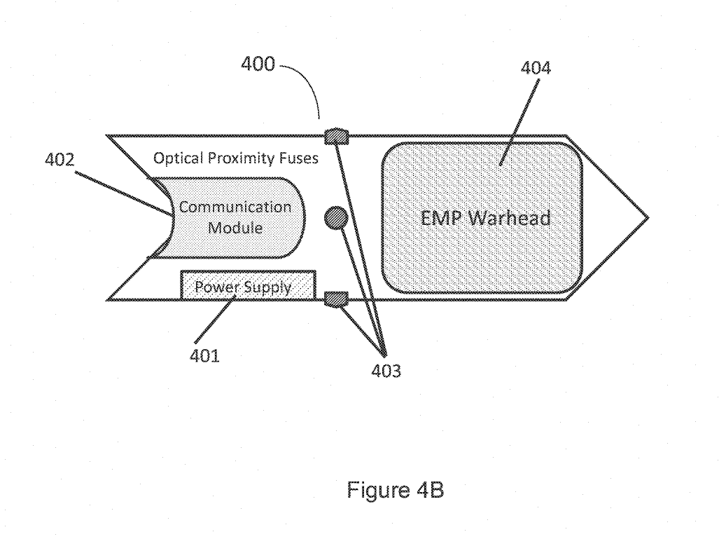

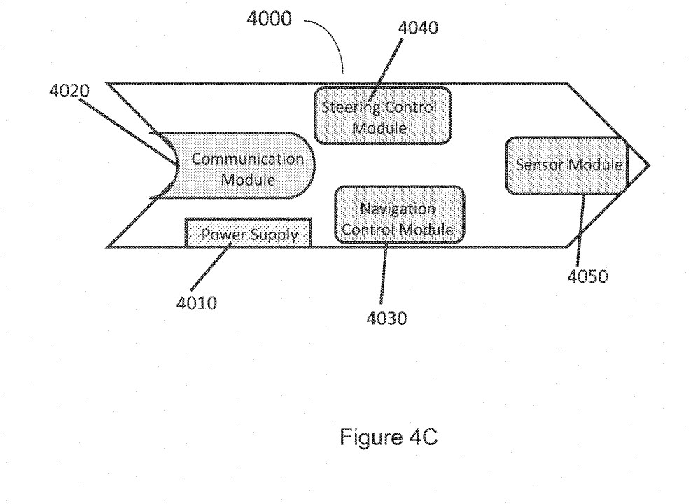

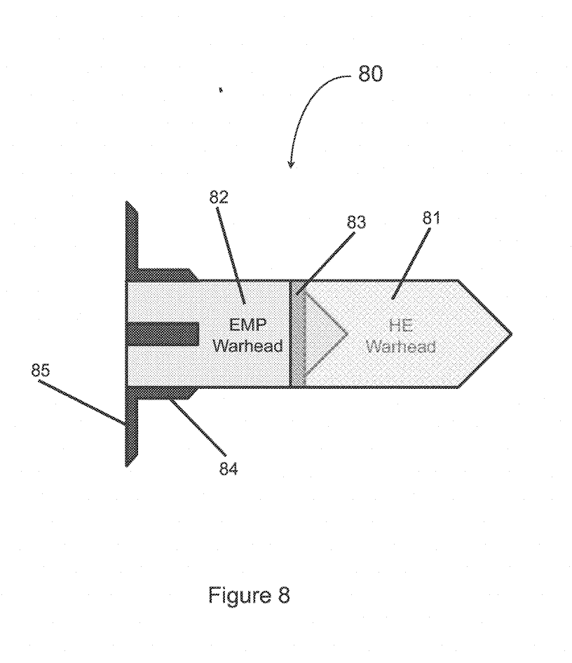

Those versed in the art will readily appreciate that the teachings of the presently disclosed subject matter are not bound by the system illustrated in any one of FIGS. 4A, 4B and 8, and equivalent and/or modified functionality can be consolidated or divided in another manner.

Those skilled in the art will appreciate that more or fewer modules and/or processors than those shown in FIGS. 4A, 4B and 8 may be used to implement the presently disclosed system, and that the various functionalities ascribed to the various modules and/or components in FIGS. 4A, 4B and 8 may be divided differently between the various components and/or modules.

Conversely, features of the invention which are described for brevity in the context of a single embodiment or in a certain order, may be provided separately or in any suitable subcombination, including with features known in the art.

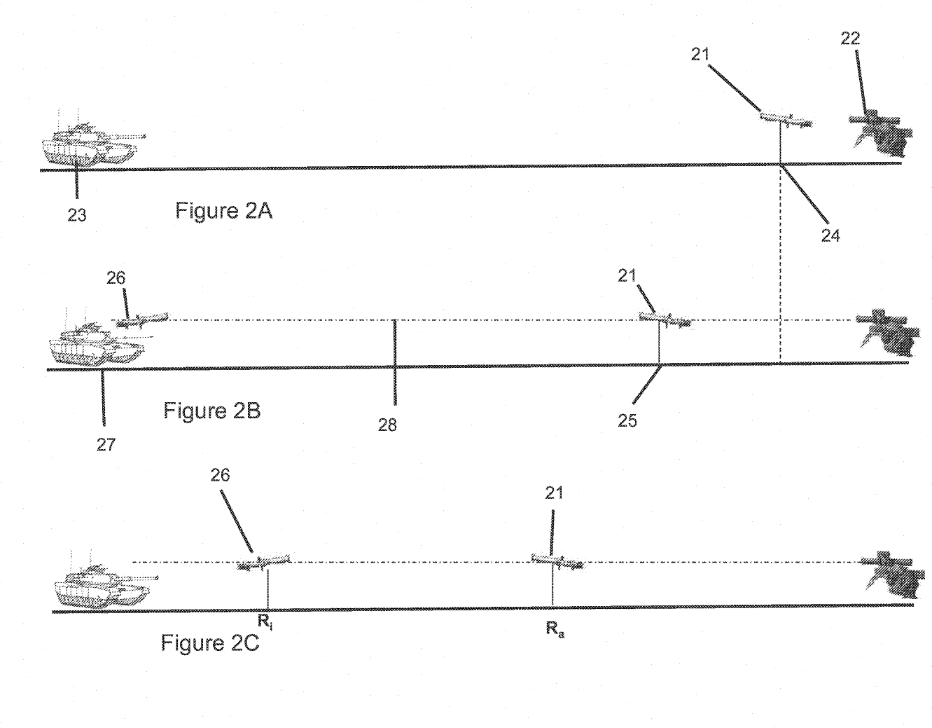

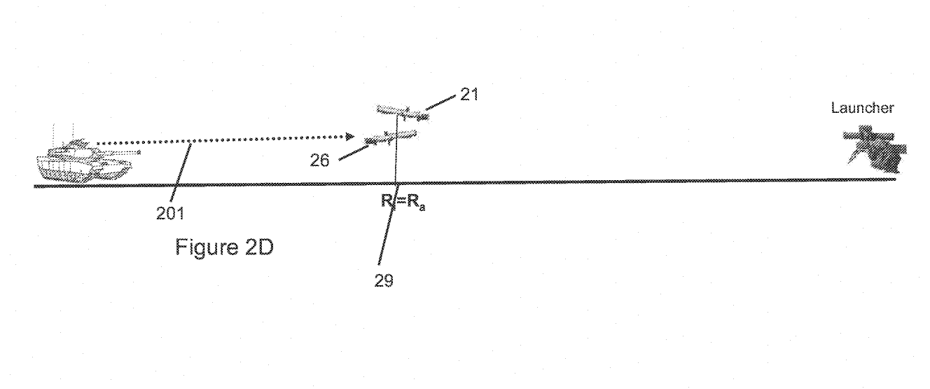

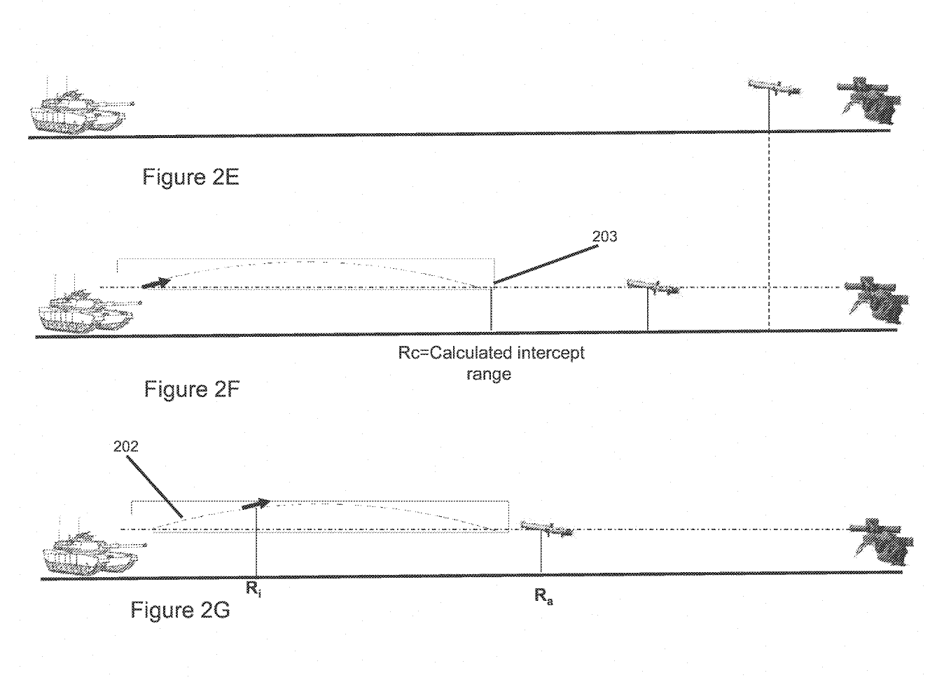

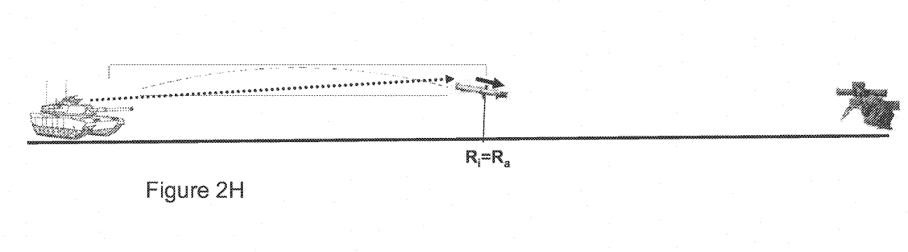

Attention is first drawn to FIGS. 2A-D illustrating a schematic chart of an operational scenarios of a Self Protection System (SPS) for stand-off neutralization of a threat, in accordance with certain embodiments of the invention.

Turning now to FIG. 2A, and as shown, an Anti-Tank-Guided Missile (ATGM) (e.g. missile 21 is fired from launcher 22, generally towards the protected platform, such as a tank 23 employing the SPS system (“the system”) of the invention (not shown in FIG. 2) that is fitted onto the protected platform 23.

The missile is not a priori classified as a threat but rather detected after a relatively short time duration 24 by a detection module of the system (not shown in FIG. 2). The detection module may be a known per se active means such as a radar module and/or passive means, such as an optical (e.g. Infra-Red, SWIR, UV, etc.) module associated with a computer system. After having detected the flying object (at this stage not classified, as yet, as a target missile) there follows a verification stage (see FIG. 2B) for classifying the flying object as a target (ATGM) that is aimed at the protected platform 23. As shown, this may occur after elapse of a verification time interval 25 during which the missile continues its flight trajectory towards the protected platform 23. The verification phase is realized by a known per se verification module (employing e.g. the specified optical module and associated computer system) and may include tracking the flying object and determining, based on measured and processed Angle of Arrival (AOA) and/or calculating the velocity vector of the approaching object, for ascertaining whether the object is flying towards the protected platform (in which case it may be classified as a ATGM threat) or not, in which case it may be ignored as it does not pose any risk to the protected platform, all as will be discussed in greater detail below. It should be noted that measured and processed AOA is only a non-limiting example for determining whether the object is flying towards the protected platform. It should be further noted that in accordance with certain embodiments an object may be classified as a true threat by using additional or other criteria.

After having classified the target as a threat (ATGM), the interception process commences as described with reference to FIG. 2B. Note that by this embodiment the interceptor 26 is a missile.

Thus, the ATGM threat (now being duly classified as a threat) is tracked (utilizing e.g. radar and/or optical module of the system) and fire characteristics of the interceptor of the SPS (SPS-I) (“the interceptor”) are calculated, such that the threat will fall within an Electro-Magnetic-Pulse induced neutralization geometric envelope relative to the interceptor, for achieving a neutralization effect of the threat, all as will be explained in greater detail below. Note that the envelope's dimensions are induced by the electro-magnetic-pulse warhead of the interceptor.

The fire characteristics may include calculating flight direction towards an optical signature that originates from the launcher or from the target missile, e.g. a flash originating from the act of launching of the ATGM threat, or e.g. detecting the optical signature of the ATGM's engine during its flight trajectory. Next, the interceptor missile 26 is fired 27 towards the target missile in accordance with the fire characteristics (as indicated by the planned flight trajectory—marked by hashed line 28) towards the launcher 22 (or the target missile 21). Although not shown in FIG. 2, the interceptor 26 is equipped with an Electro-Magnetic-Pulse warhead, all as will be discussed in greater detail below.

Next, and as shown in FIG. 2C, the ranges of both the interceptor 26 (Rᵢ) and the ATGM threat 21 (Rₐ) are tracked (e.g. utilizing the radar module of the system) until the rangers thereof substantially coincide (see 29 of FIG. 2D), in response to which an activation command is invoked 201 for activating the EMP warhead and neutralizing the target missile. As will be discussed in greater detail below, the coincidence of the ranges may be determined, e.g. by remote active means fitted on or near the protected platform, and/or in accordance with certain embodiments by at least one proximity fuse module (e.g. optical) configured to determine when the two objects (the interceptor and the ATGM threat) cross each other as depicted e.g. in FIG. 2D.

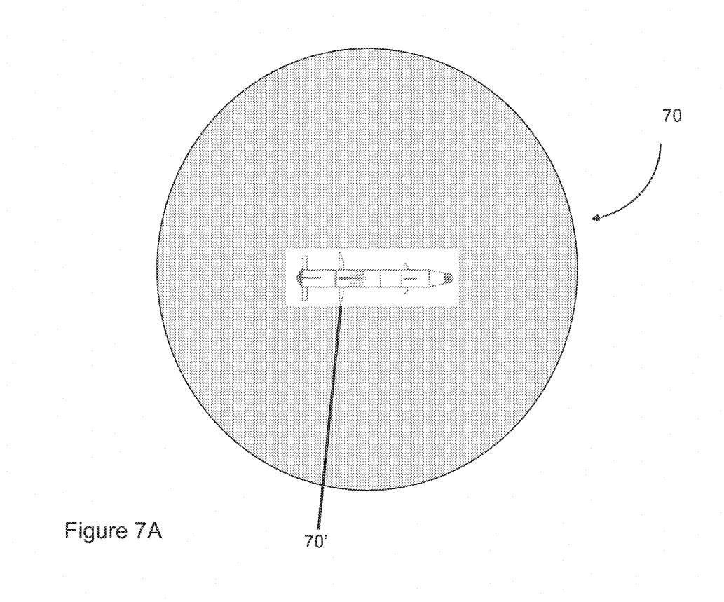

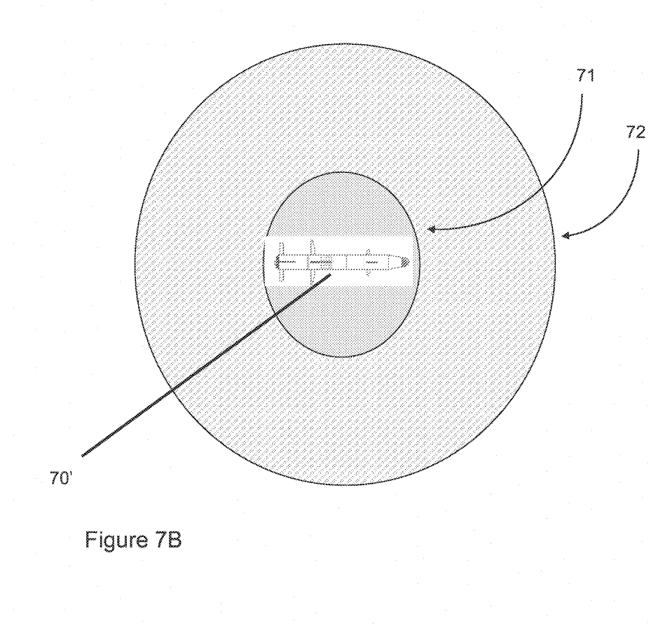

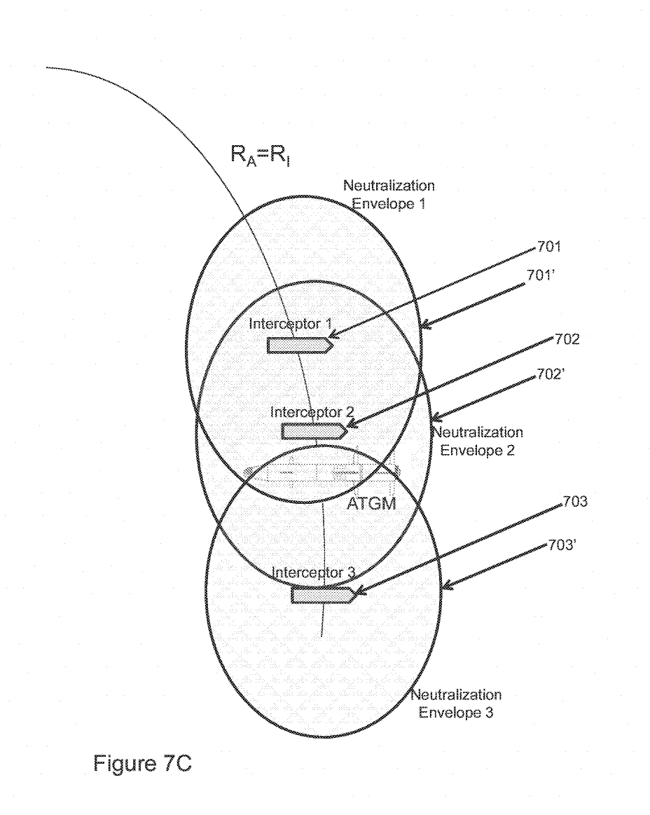

It should be noted that the specified substantial coincidence between the ranges should meet the condition that such that the threat will fall within an Electro-Magnetic-Pulse induced neutralization geometric envelope relative to the interceptor (see FIG. 7A below), thereby achieving the desired neutralization of the ATGM threat.

Note that the specified range of interception may be more than 2000 meters, or in accordance with another example more than 1000 meters, or in accordance with another example more than 500 meters, or in accordance with another example more than 200 meters, e.g. depending on the range from which the ATGM is being launched for the first time. Note that the invention is not bound by these examples, and accordingly, in accordance with certain embodiments, the range may be in the order of hundreds of meters, or more than a kilometer.

Bearing this in mind, attention is now drawn to FIGS. 2E-H depicting a similar neutralization scene (as in FIGS. 2A-D), this time with respect to a rocket or projectile type interceptor. The description with reference to FIGS. 2E-H is similar to that of FIGS. 2A-D, respectively, mutatis mutandis. The main difference is that the interceptor in this particular example is a projectile (or a rocket) having ballistic flight trajectory (see e.g. 202 in FIG. 2G), in contrast to the substantially flat trajectory of the missile type interceptor.

Thus, the object is verified as an ATGM threat (FIG. 2F) in a similar fashion to that described with reference to FIG. 2B, then based on at least the missile velocity and range, as well the interceptor's velocity and trajectory and possibly other ambient parameters, a fire elevation angle of the interceptor is calculated such that it will descend and fall giving rise to the threat falling within an Electro-Magnetic-Pulse induced neutralization geometric envelope relative to the interceptor (203).

By a calculation, the specified condition should be met (falling within the specified envelope) when a range (R_{C}) is calculated to be substantially equal to the range of the approaching threat and the flying interceptor. Once the fire characteristics are calculated, the interceptor is fired in accordance with the specified characteristics (by this example, in addition to the fire direction, also the fire elevation angle) and as further shown in FIGS. 2G and 2H both objects approach the interception point while their respective ranges (Rᵢ and Rₐ) are tracked. Once their ranges coincide (e.g. Rᵢ=Rₐ, see FIG. 2H) the warhead is activated in a similar fashion as described above with reference to FIG. 2D, to achieve the specified hard kill or soft kill, whichever the case may be.

As described above, the coincidence of the ranges (i.e. the activation of the EMP warhead) may be determined by utilizing active means such as a radar module or at least one proximity fuse module, all as discussed herein).

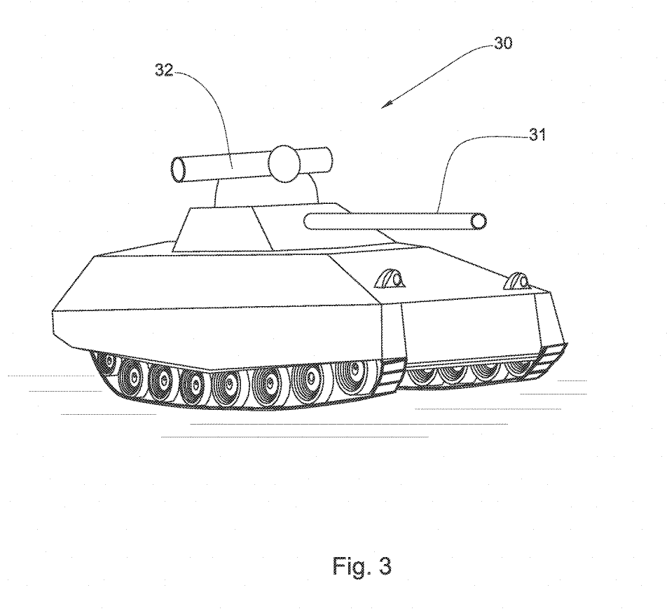

FIG. 3 is a schematic illustration of an SPS system layout, mounted on a protected platform, in accordance with certain embodiments. The protected platform is, by this example, a tank 30 and the gun 31 may fire either a conventional projectile or, if desired, a projectile employing an ERP warhead, or a barrel fired interceptor missile employing an EMP warhead, all in accordance with certain embodiments of the invention. Whilst using the tank's integral gun 31 constitutes an advantage in the sense of utilizing the existing infrastructure of the tank and avoiding the need to install add-on modules (such as a distinct missile launcher), this is achieved at the penalty of reducing the availability of the main gun for other purposes (when firing an EMP warhead ammunition).

By an alternative embodiment, the interceptor is a missile or a rocket and accordingly a distinct launcher is mounted on the tank (see e.g. 32) allowing fire of the missile or a rocket (in the latter case the launcher should facilitate modification of the elevation angle, as per the calculated fire characteristics). By this embodiment the gun may be used for shootings as required without jeopardizing the protection of the platform as the system of the invention can utilize the launcher 32 even when the gun 31 is used for firing at designated targets. Note that the launcher/projectile are not necessarily mounted on the protected platform and may be located in the vicinity thereof (e.g. in case of a building).

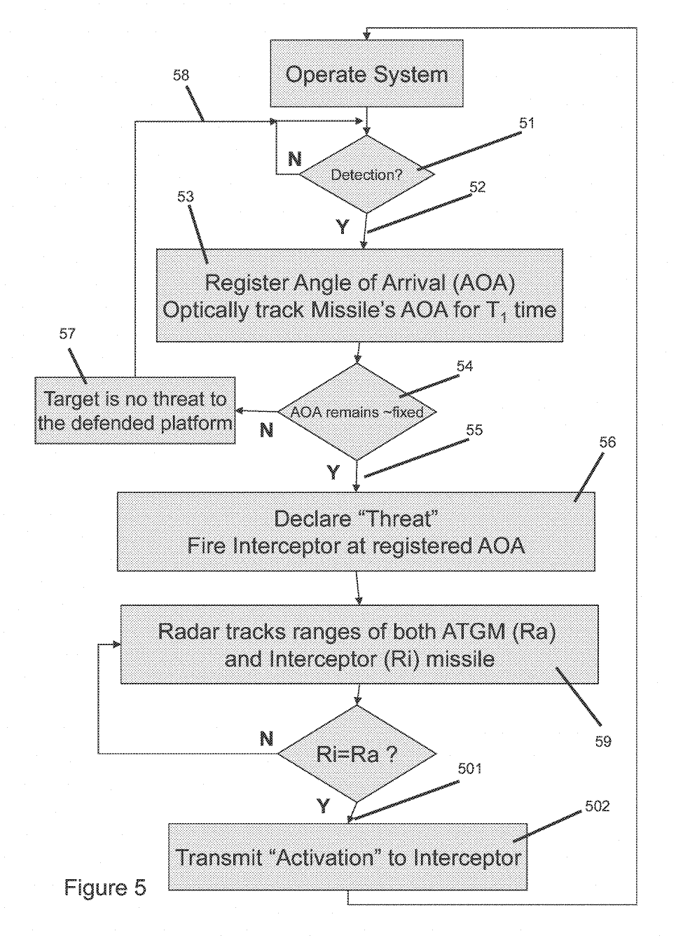

Turning now to FIG. 4A, it illustrates a generalized SPS control (SPS-C) architecture 40, in accordance with certain embodiments of the invention. As shown, the SPS-C employs a power supply 41 possibly serving as power supply of the protected platform. The system further employs a passive tracking system 42 (such as an optical detector tracker), for receiving images of the threat and the interceptor. As will be evident from the description below (with reference to FIG. 5), the passive tracking system may serve, among others, for detecting the target (potential threat) by detecting an optical signature associated with the threat's launcher or the threat itself and measuring their Angle of Arrival (AOA) and also for verifying that it is a true ATGM threat and later on for tracking the interceptor and the ATGM threat.

In addition or instead of the passive tracking system, the SPS-C may employ an active tracking system 43 (such as Radar) that may measure the range (and/or the AOA) of the interceptor as well as the ATGM and eventually serve for meeting the condition for activating the warhead of the interceptor (e.g. in case of coincidence of ranges of the ATGM threat and the interceptor, as discussed with reference to FIG. 2 above). The control of the entire sequence of operations may be performed by a computer system 44 that may control the firing (after determining the fire characteristics as described above) and eventually transmit, using the communication module 48, a warhead activation command 45 to the interceptor 46 and activate the EMP warhead 47 and achieve the desired soft or hard kill as described with reference to FIG. 2 above. Note that the invention is not bound by any specific architecture of fitting the EMP warhead onto the missile. Note that in case that active means are not used, thereby depriving the option of tracking the ranges or possibly in other scenarios, known per se proximity fuse module(s) that is (are) fitted on the interceptor may indicate when the interceptor crosses the ATGM threat (practically when the ranges substantially coincide) to activate the EMP warhead. By the latter embodiment the activation of the warhead will be on-board and not through a transmission of a command 45 from SPS-C 40 (through communication module 48). In accordance with certain embodiments, a radar of a degraded accuracy may be employed in conjunction with the proximity fuse module. Thus, when the ATGM threat and the interceptor are within a range tolerance from each other (e.g. as may be determined by the radar), the SPS-C may transmit, through communication module 48, a triggering command (45) for initiating the operation of the proximity fuse module. Control is then shifted from the radar to the proximity fuse which will trigger the activation of the warhead when the specified ranges (substantially) coincide. Obviously due to the higher accuracy of the fuse (compared to the degraded radar), the former, rather than the latter, may secure activation of the warhead at the right location (which may be beyond the accuracy limitation of the abovementioned radar).

The invention is not bound by the specified modules of the system architecture of FIG. 4 and accordingly some of the modules may be modified, others may be added all as required and appropriate.

Turning now to FIG. 4B, it illustrates schematically, components that are fitted in an interceptor (SPS-I), in accordance with certain embodiments of the invention. Thus, interceptor 400 (by this example, a projectile) includes a power supply unit 401, a communication module 402 (for receiving commands 45), optical proximity fuse modules 403 (disposed e.g. around the projectile's external surface—of which three are schematically shown in FIG. 4B) and EMP warhead 404.

The invention is not bound by the specified exemplary components and accordingly the interceptor may employ additional components. Thus, for example in case that the interceptor is a missile, it may employ additional components such as propulsion, guidance, navigation and steering modules (not shown in FIG. 4B).

Turning now to FIG. 4C, it illustrates a schematic illustration of electric/electronic modules fitted in an ATGM threat, in accordance with certain embodiments of the invention.

As explained above, upon activation of the EMP warhead, provided that the threat falls within the neutralization envelope (relative to the threat), a soft kill or hard kill is achieved which may cause permanent or temporary neutralization of the electronic/electric modules of the ATGM threat 4000. The specified modules may be any one or one or more of the power supply module, 4010, the communication module 4020 (configured to receive commands and input from the ATGM launcher/control), Navigation control Module 4030 (e.g. inertial system) for determining the missile's spatial location, steering control module 4040 for controlling e.g. the missile's fins or thrust vectored nozzles for maneuvering it in a desired flight trajectory, possibly sensor module 4050, e.g. an optical or radar module which may be activated at the endgame facilitating an autonomous guiding of the missile and home onto the target at the end-game, etc. The specified modules are provided for illustrative purposes only and are by no means binding. Neutralizing one or more of the specified modules, whether temporarily or permanently, may disrupt the operation of the missile, thereby missing its target (namely the protected platform).

Note that components in various drawings (FIGS. 3 and 4) are depicted for illustrative purposes only, for instance not in scale that resembles that of the components in a real implementation.

Bearing this in mind, attention is drawn to FIG. 5 illustrating a flow chart of a sequence of operations for realizing a stand-off neutralization of a threat (ATGM) with a single stage interceptor missile (SPS-I) of an SPS system, in accordance with certain embodiments of the invention. As shown, by utilizing optical detector tracker (e.g. 42 of FIG. 4A) and/or radar (e.g. 43 of FIG. 4A), a detection step 51 is effected until known per se detection of an oncoming object 52 (see also FIG. 2A) is achieved. After having detected the object, there follows a verification step for classifying the object as an ATGM aimed at the protected platform. This may be achieved e.g. by registering, in a database (not shown in FIG. 4), for a given time duration (say T₁) the measured and processed Angle of Arrival (AOA) of the oncoming object 53 and in case that it is retained substantially fixed (within a given tolerance) (54), then the object is classified as a true threat (55) (see also FIG. 2B) and firing characteristics are calculated such that the ATGM threat will fall within an Electro-Magnetic-Pulse induced neutralization geometric envelope relative to the interceptor, for achieving a neutralization effect of the threat (as discussed in detail herein), and the interceptor missile is then fired 56 based on the specified firing characteristics.

Note that in case the object is not classified as a true threat 57, it is ignored and the detection stage 58 is resumed.

Reverting to step 56, as specified above, the fire characteristics may include calculating (e.g. in computer system 44) flight direction towards an optical signature that originates from the launcher or the target missile, e.g. a flash originated from the act of firing of the ATGM threat, or e.g. detecting the optical signature of the ATGM's engine during its flight trajectory. Assuming that by this embodiment the system employs also active means such as radar (e.g. 43 of FIG. 4A) then the radar tracks ranges of both the interceptor and the ATGM (59) (see also FIG. 2C) and when the ranges substantially coincide 501, an activation command is invoked 502 for initiating the EMP warhead (e.g. 47 fitted on the missile 43, both of FIG. 4A), for achieving a stand-off neutralization of the threat at a range substantially farther than the end-game intercept range, and irrespective of the type of the target (see also FIG. 2D). It should be noted that whilst in this example the condition is that the ranges coincide, a successful neutralization, whether hard kill or soft kill, may be duly achieved even if the ranges do not exactly, but rather substantially, coincide. The latter may occur, whether by a control decision, or due to circumstances such as inherent errors induced by the command and control system (the various modules of the SPS-C as described, by way of example, with reference to FIG. 4A), and/or the modules of the interceptor, atmospheric and or other ambient influences and/or possibly other circumstances. The specified neutralization will be achieved for as long as the accumulated errors shall not result in deviating from the specified neutralization envelope (bounding the ATGM threat relative to the interceptor), all as discussed herein, and as will be further exemplified with reference to FIGS. 7A-7C below.)

As also discussed above with reference to FIG. 4A, the specified sequence of operations may be implemented mutatis mutandis without necessarily employing the specified modules. For instance, in case the SPS control 40 does not employ active means (e.g. Radar), then the ranges of the ATGM threat and the interceptors are not tracked (i.e. step 59 is not implemented) but nevertheless the coincidence of the ranges may be determined, e.g. by a proximity fuse module fitted onto the interceptor (shown in FIG. 4B) and the initiation of the EMP warhead for neutralization of the ATGM threat may be performed on-board the interceptor rather than by a command transmitted from the remote command and control.

It should be thus noted that the invention is not bound by the specified sequence of operations described with reference to FIG. 5, and accordingly some of the designated steps may be modified and/or deleted and or others may be added, all depending upon the particular application.

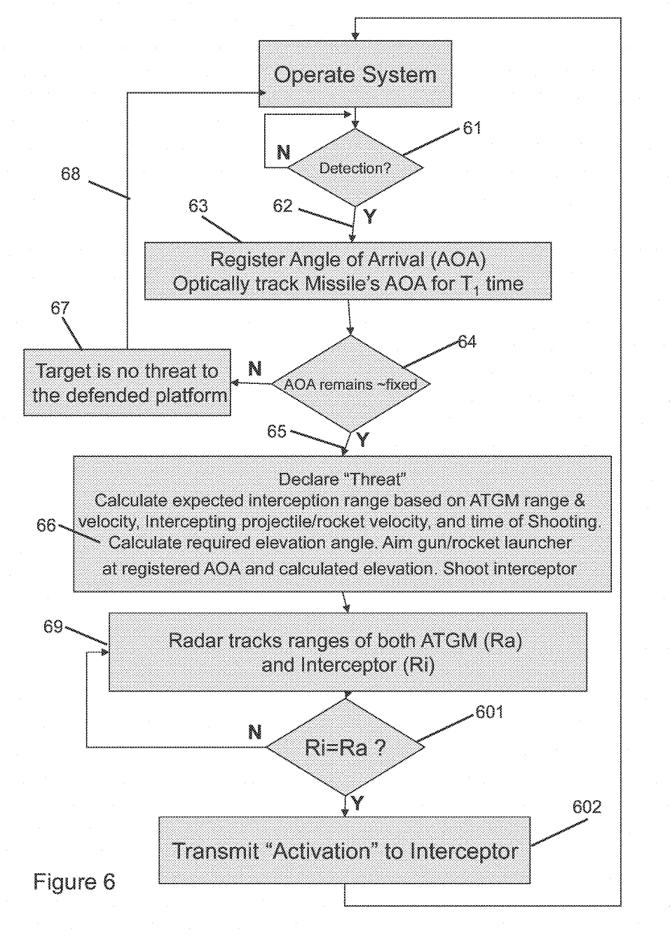

Bearing this in mind, attention is drawn to FIG. 6, illustrating a flow chart of a sequence of operations for realizing a stand-off neutralization of a threat (ATGM) with a single-stage interceptor of an SPS, in accordance with certain embodiments of the invention, utilizing a rocket or projectile. As shown, the operational stages in steps 61, 62, 63, 64, 65, 67, 68, 69, 601 and 602 are similar mutatis mutandis to those described with reference to corresponding steps 51, 52, 53, 54, 55, 57, 58, 59, 501 and 502. Note that the fire characteristics of the missile step 56 (with reference to FIG. 5) are different to those of the rocket/projectile 66. Thus, in the latter, in accordance with certain embodiments, expected interception range based on ATGM's range, velocity (derived e.g. from the radar module 43 of FIG. 4A), intercepting projectile/rocket velocity, and time of firing are processed for determining desired elevation angle of the fired projectile, and the firing is performed at the calculated elevation angle.

As discussed above, in accordance with certain embodiments, by virtue of the higher velocity of the projectile interceptor (see e.g. FIG. 2H) relative to the missile interceptor (see e.g. FIG. 2D) the former is likely to intercept the ATGM at a longer distance from the protected platform compared to the latter, leaving thus an even longer time duration for a second chance to neutralize the threat (e.g. by firing a second projectile) in case of a first missed ATGM, assuming that the whole sequence of operations, until the interceptor is fired, is substantially similar for both cases.

Turning now to FIG. 7A, it illustrates schematically an Electro-Magnetic-Pulse induced neutralization geometric envelope 70, for stand-off neutralization engagement by an interceptor, in accordance with certain embodiments of the invention, and also to FIG. 7B illustrating schematically an Electro-Magnetic-Pulse induced neutralization geometric envelope, for stand-off neutralization engagement, broken down by hard kill 71 and soft kill 72 envelopes, in accordance with certain embodiments of the invention. It should be noted that the specified envelopes are depicted for illustrative purposes only and do not represent the actual calculated envelope that is valid for a true ATGM neutralization.

As specified above, the ATGM threat should fall within the Electro-Magnetic-Pulse induced neutralization geometric envelope 70 relative to the interceptor 70′ (see FIG. 7A), thereby achieving the desired neutralization of the ATGM threat. It should be further noted that by virtue of the EMP warhead, the specified neutralization geometric envelope has a larger volumetric dimension (by a factor of at least 10) than the volumetric dimension of the envelope of a High-Explosive (HE) warhead with substantially the same size and/or weight as that of said EMP warhead, for achieving substantially the same neutralization effect (not shown in FIGS. 7A-B).

It should be further noted that by virtue of the relatively large geometric envelope, even if the interceptor missile deviates from its planned trajectory (e.g. toward the optical signature that originated from the launcher) due to various intrinsic factors, such as errors induced by the interceptor's electronic or mechanical modules, SPS-C errors, and/or extrinsic factors such as atmospheric or other ambient induced errors, the interceptor will nevertheless achieve the specified neutralization effect provided that its deviations (as well as deviations of the ATGM threat) will still result in that the ATGM threat falls within the specified geometric neutralization envelope. This large envelope may enable a successful neutralization of the threat even in cases where the interceptor is a projectile or rocket.

Still further it should be noted, that in accordance with certain embodiments, the specified large neutralization envelope further alleviates certain strict design considerations of the interceptor operational specifications insofar as accuracy tolerances is concerned (i.e. allowing it to be less accurate), thereby reducing the price tag of each missile. This is advantageous since a large number of these interceptors is required to match (for neutralizing in a combat scenario) the huge numbers of ATGMs that are typically used during war nowadays.

It should be further noted that the neutralization of the ATGM threat may be achieved by a so called hard kill wherein said neutralizing may include permanently rendering inoperable of at least one of electronic/electrical modules of said ATGM threat (e.g. destroying or reducing the attacker lethality). Note that “Hard Kill” that is achieved at a long range—remedies the shortcomings of possible misses by allowing activation of backup kill means (possibly even firing another interceptor towards the oncoming threat) since there is ample time to activate the backup neutralizing means due to the relatively large ranges that the ATGM threat should fly before it hits the protected platform. In contrast, in case of hard kill that is designated to be achieved at a short distance (e.g. as in the prior art Trophy™ system) there is not ample time to activate backup threat kill solutions in case of miss, thereby jeopardizing the protected platform.

In accordance with certain embodiments, a soft kill is achieved wherein said neutralizing may include temporarily rendering inoperable at least one of the electronic/electrical modules of said ATGM threat (e.g. jamming the ATGM threat) by means that do not actually damage it, but rather “temporarily blind” it, thereby causing it to miss the defended target, or in many cases stray, miss its course, and smash to the ground shortly thereafter. It is thus noted that the soft kill that is achieved in accordance with various embodiments of the SPS of the invention is designated to neutralize the ATGM threat, and not its launcher control, and it is not tuned to a specific ATGM, and thus does not need to identify the type of the ATGM.

Note that in accordance with the prior art system, soft kill solutions that are designated to achieve a soft kill of the threat at a long distance are typically designated to jam or deceive the launcher which controls the flight of the missile, causing it to send erroneous commands to the missile.

Note also that disrupting the operation of the launcher control may not be an easy task considering the advanced capabilities that are typically embedded in the launcher control allowing it to apply counter measure means against the specified launcher control disrupting techniques. In particular, it is even harder to employ a universal soft kill mechanism that will be efficient against all possible launcher capabilities.

To the extent that known soft kill mechanisms (at large range) are designated against the oncoming missile itself (e.g. those employing a television or radar warhead), such a known soft-kill mechanism should be configured to operate against a specific threat and do not offer a universal solution.

In contrast, in accordance with various embodiments of the invention, by virtue of employing the EMP warhead the soft kill is achieved at a long range and will permanently or temporarily disrupt the ATGM threat functionality, irrespective of the type of the missile, thereby offering a true universal solution.

By the same token, prior art soft kill mechanisms which target the launcher require identification of the incoming missile and a priori knowledge of the technique that is required to successfully jam this missile/launcher. In contrast, in accordance with various embodiments of the invention there is neither a need to identify the missile nor a priori knowledge in order to achieve successful neutralization.

Note (with reference to FIG. 7B) that a hard kill would typically prescribe a smaller envelope (71) e.g. closer proximity of the interceptor relative to the ATGM compared to an envelope 72 (e.g. distance), had the interceptor achieved a soft kill neutralization, as will be discussed below.

Turning now to FIG. 7C, it illustrates an Electro-Magnetic-Pulse induced neutralization geometric envelope in various operational scenarios, in accordance with certain embodiments of the invention. Thus, as may be recalled, the interceptor may deviate from its designated trajectory due to various reasons such as inherent errors induced by the SPS-C (the various modules of the system as described, by way of example, with reference to FIG. 4A), and/or the modules of the interceptor, atmospheric and or other ambient influences and/or possibly other circumstances. FIG. 7C illustrates schematically three distinct scenarios 701, 702 and 703 and their corresponding neutralization envelopes 701′, 702′ and 703′ of various deviations of the interceptor from its designated trajectory, with the result that a successful kill will be achieved for all scenarios. Note that the specified scenarios are examples only.

Turning now to FIG. 8 it illustrates a dual-stage interceptor of an SPS (SPS-I), in accordance with certain embodiments of the invention. As shown the interceptor 80 is composed of two major separable parts: the HE warhead 81 and EMP warhead 82. The parts are connected to each other e.g. by remotely commanded explosive driven connectors or latches 83. The EMP warhead includes all or part of the elements described in FIG. 4B, but in addition may include spring loaded, remotely controlled explosive released spoilers (airbrakes). FIG. 8 illustrates both states of the spoilers i.e. folded 84 and expanded 85. The EMP warhead 82 further includes a receiver configured to receive separation, spoiler release and EMP warhead initiation commands.

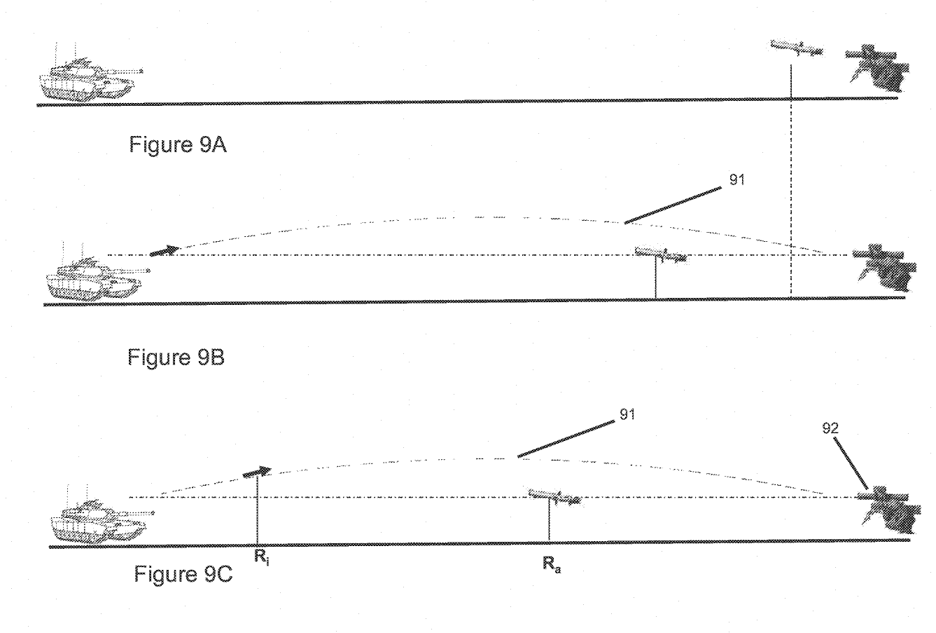

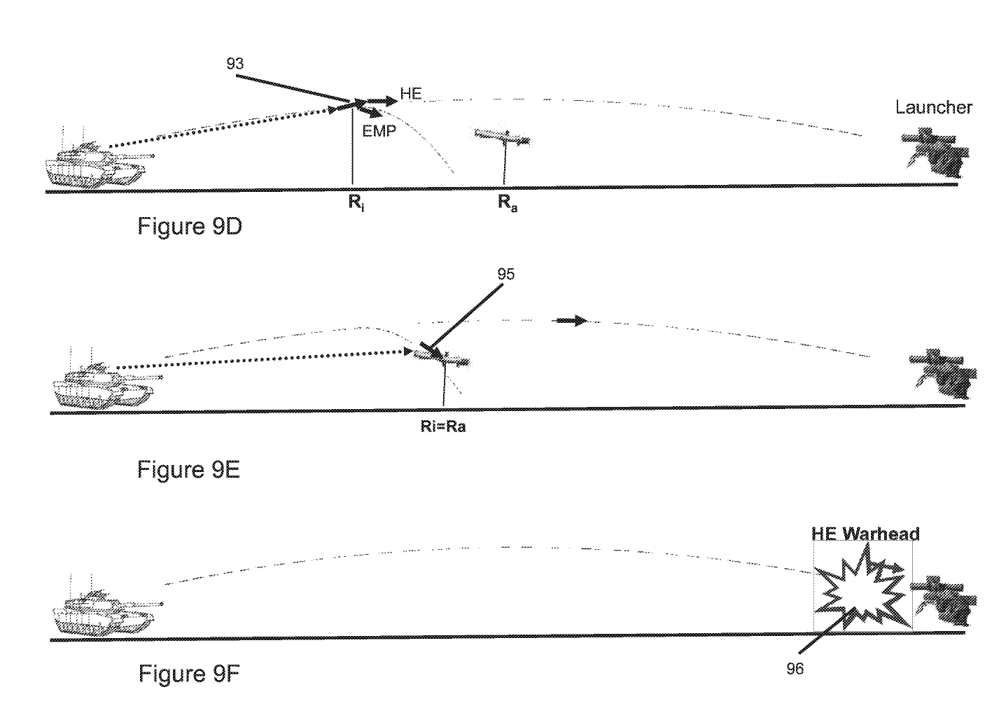

Attention is now drawn to FIGS. 9A-F which illustrate schematic charts of an operational scenario of an SPS, for stand-off neutralization of a threat utilizing a dual-stage interceptor, in accordance with certain embodiments of the invention. Typically, although not necessarily, the dual stage interceptor would be a projectile.

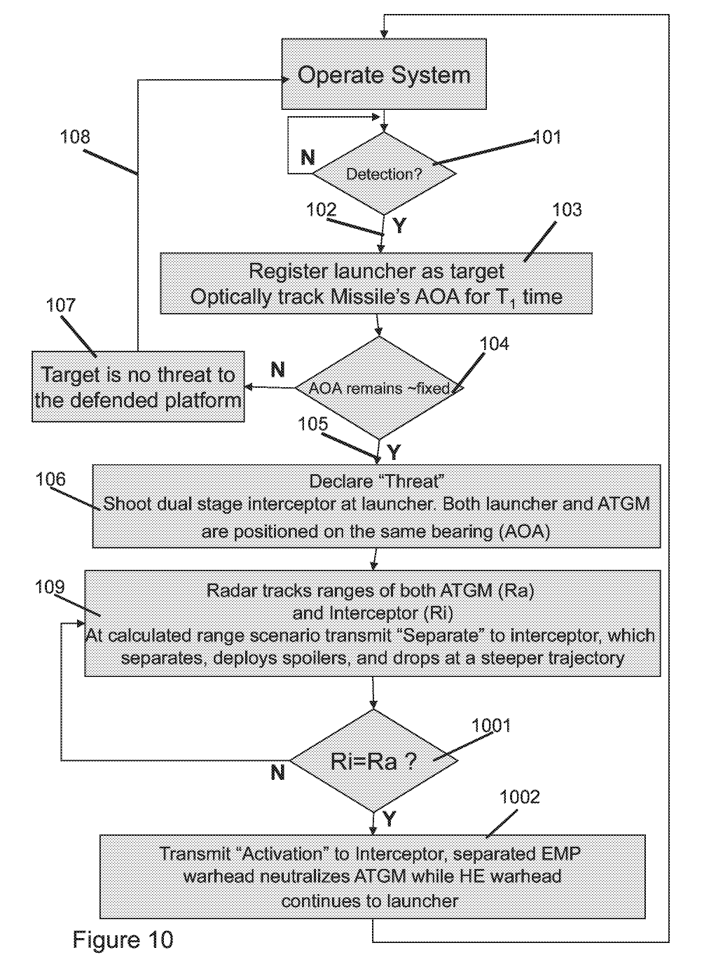

Attention is also drawn to FIG. 10 which is a flow chart of a sequence of operations for realizing a stand-off neutralization of a threat (ATGM) and a launcher with a dual stage interceptor of a system (SPS-I), in accordance with certain embodiments of the invention.

The detection and verification stages as illustrated in FIGS. 9A-B are similar to those described with reference to FIGS. 2E-F with respect to a single stage projectile. Thus, detection and verification steps 101, 102, 103, 104, 105 and 107 (of FIG. 10) correspond to steps 61, 62, 63, 64, 65 and 67 of FIG. 6 (with reference to a single stage projectile interceptor). As arises from FIG. 9C and in contrast to the single stage interceptor scenario of FIG. 2G, the interceptor trajectory 91 is designated to hit the launcher and appropriate fire characteristics are calculated (with the relevant elevation firing angle). This is illustrated also in step 106.

Then, as discussed above, the active means track both the ATGM threat and the interceptor (see FIG. 9C) and at a certain stage a separation command is transmitted and the EMP warhead (see 82 in FIG. 8) is separated and the spoilers may be released to their open state (see 85 of FIG. 8) and cause deceleration and a steeper descend trajectory (see 93 of FIG. 9D and step 109). The separation command is calculated (in computer system 44) so that the EMP warhead will descend and the ATGM will enter the specified envelope for neutralizing of the ATGM in the manner described in detail above (see 95 in FIG. 9E). As illustrated in step 1001 and 1002 once entering to the specified envelope is achieved, e.g. the range of the warhead and the ATGM missile match (or substantially match as long as they fall within the specified envelope) the warhead is activated, e.g. by means of a remote command transmitted from the SPS-C (as determined by computer system 44 of FIG. 4A), or e.g. by a proximity fuse(s) all as discussed in detail above. As shown in FIG. 9F, after separation, the HE warhead 81 continues to fly along the specified trajectory for hitting the launcher 96 or the vicinity thereof.

Reverting now to FIG. 2B, in accordance with an aspect of the invention, in case that the object is classified as a threat (in the manner described above) and in case the threat is of the specified first or second generation type (which requires remote command and control of the threat until it hits the protected platform), the specified SPS interceptor (by this embodiment a projectile employing the specified EMP warhead) may be fired at the direction and range of the launcher (as identified e.g. in response to sensing optical signature originated from the launch of the threat) and assuming that the fast flying projectile arrives at the launcher earlier than the threat arrives at the protected platform, then by virtue of the large envelope (compared to an envelope had a high explosive warhead been employed all as discussed above), there is a high likelihood that even in-accurate hit of the projectile at a relatively large distance from the launcher (or human operator) the launcher will be neutralized and consequently the threat, no longer controlled by the launcher) will miss the protected platform. By this embodiment, a simplified projectile (compared to the interceptor described with reference to FIG. 4B or 8) that is devoid of communication and other modules (except from the EMP warhead) as well a degenerated SPS control, which is exempted of controlling the operation of the projectile after being fired, the threat is eliminated because the launcher is subjected to hard of soft kill (which the case may be) and consequently it is neutralized from controlling the flight of the threat necessarily leading to missing the protected platform by virtue of lack of control. By this example, the projectile flies towards the target such that launcher falls within the envelope (of say FIG. 7A—relative to the projectile).

It should be noted that the specified launcher neutralization may be employed in addition or in lieu of the threat neutralization discoed above.

It is to be understood that the presently disclosed subject matter is not limited in its application to the details set forth in the description contained herein or illustrated in the drawings. The presently disclosed subject matter is capable of other embodiments and of being practiced and carried out in various ways.

1-35. (canceled)

36. A method for neutralizing a threat, comprising:
a) detecting an oncoming object prima facie aimed at a protected platform;
b) in response to said detecting, classifying the object as an Anti-Tank-Guided Missile (ATGM) threat;
c) in response to said classification, calculating fire characteristics of the interceptor, such that the ATGM threat will fall within an Electro-Magnetic-Pulse induced neutralization geometric envelope relative to the interceptor, for achieving a neutralization effect of the threat,
d) firing said interceptor that is equipped with at least an Electro-Magnetic-Pulse warhead according to said fire characteristics,
e) in response to said threat falling within said neutralization geometric envelope, initiating the EMP warhead, for achieving a stand-off neutralization of the threat at a range substantially farther than the end-game intercept range, and irrespective of the type of the target missile;
and wherein the neutralization geometric envelope has larger volumetric dimensions by a factor of at least 10 than the volumetric dimensions of a second envelope, had a High-Explosive (HE) warhead with substantially the same size and/or weight as that of said EMP warhead been used, for achieving substantially the same neutralization effect.

37. The method according to claim 36, wherein in case said interceptor being a missile, said fire characteristics include: calculating flight direction towards an optical signature that originates from the launcher or detecting an optical signature of the ATGM's engine during its flight trajectory.

38. The method according to claim 36, wherein in case said interceptor being a projectile or rocket and said fire characteristics include calculating a fire elevation angle of the interceptor, the ATGM threat will fall within said envelope.

39. The method according to claim 36, wherein said classifying the object as an ATGM threat aimed at said protected platform, includes measuring and processing an Angle of Arrival (AOA) of the oncoming object, and in case that it is retained substantially fixed within a given tolerance, then the object is classified as said threat, or velocity vector of the approaching object is calculated for classifying said object as a threat.

40. The method according to claim 36 wherein said initiating of the EMP warhead being when the range from the interceptor's launcher to the interceptor substantially coincides with range from the interceptor's launcher to the threat.

41. The method according to claim 36 wherein said range being in the order of more than 100 meters.

42. The method according to claim 36 wherein said initiating being responsive to a range data obtained by a radar system associated with said interceptor launcher and being transmitted to said interceptor.

43. The method according to claim 36, wherein said initiating being responsive to a cross signal originating from at least one proximity fuse module fitted on-board the interceptor.

44. A Self Protection System Control (SPS-C) for neutralizing a threat, comprising:
a computer system coupled to a tracking system and communication module;
the SPS-C being configured to
a) detect an oncoming object prima facie aimed at a protected platform;
b) in response to said detecting, classifying the object as an Anti-Tank-Guided Missile (ATGM) threat;
c) in response to said classification, calculating fire characteristics of the interceptor, such that the ATGM threat will fall within an Electro-Magnetic-Pulse induced neutralization geometric envelope relative to the interceptor, for achieving a neutralization effect of the threat,
d) command firing said interceptor that is equipped with at least Electro-Magnetic-Pulse warhead according to said fire characteristics,
e) track said interceptor and said threat and in response to said ATGM threat falling within said neutralization geometric envelope relative to said interceptor, transmitting an activation command to said interceptor, for achieving a stand-off neutralization of the threat at a range substantially farther than the end-game intercept range, and irrespective of the type of the target missile,
and wherein the neutralization geometric envelope has larger volumetric dimensions by a factor of at least 10 than the volumetric dimensions of a second envelope, had a High-Explosive (HE) warhead with substantially the same size and/or weight as that of said EMP warhead been used, for achieving substantially the same neutralization effect.

45. The system according to claim 44, wherein said command is transmitted to the interceptor for initiating the EMP warhead.

46. The system according to claim 44, wherein said command is transmitted to the interceptor for activating at least one proximity fuse module fitted on said interceptor.

47. The system according to claim 44, wherein the tracking system being a passive tracking system for at least said detecting the on-coming object.

48. The system according to claim 44, wherein the tracking system being an active tracking system, for at least said detecting the on-coming object.

49. The system according to claim 44, wherein the system is configured to fire said interceptor wherein said interceptor being a missile, and wherein said computer system is configured to calculate said fire characteristics including calculating flight direction towards an optical signature that originates from the launcher or to the detection of optical signature of the ATGM's engine during its flight trajectory.

50. The system according to claim 44, wherein the system is configured to fire said interceptor wherein said interceptor being a projectile or rocket and wherein said computer system is configured to calculate said fire characteristics including calculating a fire elevation angle of the interceptor such that the ATGM threat will fall within said envelope.

51. The system according to claim 44, wherein said computer system is configured to classify the object as an ATGM threat aimed at said protected platform including processing an Angle of Arrival (AOA) of the oncoming object and in case that it is retained substantially fixed within a given tolerance, then the object is classified as said threat or calculating the velocity vector of the approaching object for classifying said object as a threat.

52. The system according to claim 44, wherein said initiating of the EMP warhead being when the range from the interceptor's launcher to the interceptor substantially coincides with range from the interceptor's launcher to the threat missile.

53. The system according to claim 44, wherein said range being in the order of more than 100 meters.

54. The method according to claim 44, wherein said protected platform being a tank.

55. A Self Protection System Control (SPS-C) for neutralizing a threat, comprising:
a computer system coupled to a tracking system and communication module;
the SPS-C being configured to
a) detect an oncoming object prima facie aimed at a protected platform and the direction and range of the launcher in response to sensing optical signature originated from the launch of the threat;
b) in response to said detecting, classifying the object as an Anti-Tank-Guided Missile (ATGM) threat;
c) in response to said classification, calculating fire characteristics of a fast flying interceptor based on said direction and range, wherein said fast flying projectile having substantially faster flight velocity than said threat, such that the interceptor will fall within an Electro-Magnetic-Pulse induced neutralization geometric envelope relative to the launcher, for achieving a neutralization effect of the launcher,
d) command firing said fast flying interceptor that is equipped with at least Electro-Magnetic-Pulse warhead according to said fire characteristics, for neutralizing said launcher and consequently said threat before the latter has arrived at said protected platform;
wherein the neutralization geometric envelope has larger volumetric dimensions by a factor of at least 10 than the volumetric dimensions of a second envelope, had a High-Explosive (HE) warhead with substantially the same size and/or weight as that of said EMP warhead been used, for achieving substantially the same neutralization effect.
